(19) United States
(12) Patent Application Publication
(10) Pub. No.: US 2019/0251961 A1
(43) Pub. Date: Aug. 15, 2019

(54) TRANSCRIPTION OF AUDIO COMMUNICATION TO IDENTIFY COMMAND TO DEVICE

(71) Applicant: Lenovo (Singapore) Pte. Ltd., Singapore (SG)

(72) Inventors: Song Wang, Cary, NC (US); Ming Qian, Cary, NC (US); David Alexander Schwarz, Morrisville, NC (US); Jun-Ki Min, Chicago, IL (US); Mir Farooq Ali, Rolling Meadows, IL (US)

(21) Appl. No.: 15/897,604

(22) Filed: Feb. 15, 2018

(51) Int. Cl. G10L 15/22; G10L 15/18

(52) U.S. Cl. CPC G10L 15/22; G06F 3/04842; G10L 2015/223; G10L 15/1815

(57) ABSTRACT

In one aspect, a first device includes a processor and storage accessible to the processor. The storage includes instructions executable by the processor to facilitate audio communication between the first device and a second device and to select a threshold amount of the audio communication. The instructions are also executable to transcribe to text words that are recognized from the threshold amount of the audio communication, determine whether the text comprises a command to the first device, and request confirmation that a command to the first device has been issued based on a determination that the text comprises a command to the first device.

### BACKGROUND

Currently, many devices do not permit voice command recognition during a telephone call because the call and voice command software would both need to occupy the same audio channel being used for the telephone call. Some devices have sought to overcome this by employing additional hardware. For instance, one microphone on the device might be used for conducting the telephone call and a separate microphone on the device might be used for receiving voice commands provided during the call. As another example, one chipset might be used to conduct the telephone call and a separate chipset might be used for audio processing to identify commands. However, as recognized herein, this adds to manufacturing costs owing to multiple pieces of the same types of hardware having to be included on a single device, which also unnecessarily taking up valuable physical space within the device. There are currently no adequate solutions to the foregoing computer-related, technological problem.

### SUMMARY

Accordingly, in one aspect a first device includes at least one processor and storage accessible to the at least one processor. The storage includes instructions executable by the at least one processor to facilitate audio communication between the first device and a second device and to select a threshold amount of the audio communication. The threshold amount does not include the entirety of the audio communication. The instructions are also executable by the at least one processor to transcribe to text words that are recognized from the threshold amount of the audio communication, determine whether the text comprises a command to the first device, and request confirmation that a command to the first device has been issued based on a determination that the text comprises a command to the first device.

In another aspect, a method includes facilitating audio communication between a first device and a second device and selecting a threshold amount of the audio communication. The threshold amount does not include the entirety of the audio communication. The method also includes converting to text words that are recognized from the threshold amount of the audio communication, determining whether the text comprises a command to a device, and presenting a request to confirm that a command to the device has been provided based on determining that the text comprises a command to the device.

In still another aspect, a computer readable storage medium includes instructions executable by at least one processor to facilitate audio communication between a first device and a second device, convert to text at least one word that is recognized from the audio communication, and determine whether the text comprises a command to a device. The instructions are also executable by the at least one processor to present a request to confirm that a command to the device has been provided based on a determination that the text comprises a command to the device.

The details of present principles, both as to their structure and operation, can best be understood in reference to the accompanying drawings, in which like reference numerals refer to like parts, and in which:

### BRIEF DESCRIPTION OF THE DRAWINGS

FIG. 1 is a block diagram of an example system in accordance with present principles;

FIG. 2 is a block diagram of an example network of devices in accordance with present principles;

FIG. 3 is a flow chart of an example algorithm in accordance with present principles; and

FIGS. 4-6 are example graphical user interfaces (GUIs) in accordance with present principles.

### DETAILED DESCRIPTION

The present application deals with voice commands being recognized during a telephone or video conferencing call, for example, and providing a subsequent user interface for a user to acknowledge or disregard actions the device has identified to perform based on a potential voice command received during the call. This may be done using a single microphone feed rather than two feeds, one for the call and one for voice commands.

Accordingly, audio of the call may be transcribed by the device using software that, e.g., runs in the background. Audio of a defined window of time may be captured and transcribed, and then the transcription may be further analyzed by the device to determine if any word(s) from the transcription match commands in a predefined database of voice commands. When a voice command is identified within the transcription, the words of the transcription that come before and after the command itself may also be analyzed utilizing, e.g., natural language processing to determine whether there is intention to use command keywords or just regular speech for which a command should not be executed. Additionally, a “command” icon or symbol may appear on screen whenever a voice command is detected by the device as another way to confirm a user's intention to provide a voice command. Thus, the same audio channel from the same microphone as used to conduct the call itself may also be used to determine whether the user might have also provided a voice command to the device itself.

Furthermore, in some embodiments portions of the entire conversation may be recorded and transcribed separately and then discarded if those segments contain no voice command so that the device may consume relatively less memory for determining whether a voice command has been provided than had the entire call been transcribed, e.g., throughout or at the end of the call. Additionally, if a voice command was received toward the beginning or end of a recorded segment and additional context before or after the voice command would be helpful that is not actually included in that same segment (or if the command itself was cut off), the device may provide an audible prompt via speakers and/or a visual prompt via a GUI on a display for the user to repeat the command and context so that it may all be captured in a single audio segment and then that segment may be transcribed as described herein.

With respect to any computer systems discussed herein, a system may include server and client components, connected over a network such that data may be exchanged between the client and server components. The client components may include one or more computing devices including televisions (e.g., smart TVs, Internet-enabled TVs), computers such as desktops, laptops and tablet computers, so-called convertible devices (e.g., having a tablet configuration and laptop configuration), and other mobile devices including smart phones. These client devices may employ, as non-limiting examples, operating systems from Apple Inc. of Cupertino Calif., Google Inc. of Mountain View, Calif., or Microsoft Corp. of Redmond, Wash. A Unix® or similar such as Linux® operating system may be used. These operating systems can execute one or more browsers such as a browser made by Microsoft or Google or Mozilla or another browser program that can access web pages and applications hosted by Internet servers over a network such as the Internet, a local intranet, or a virtual private network.

As used herein, instructions refer to computer-implemented steps for processing information in the system. Instructions can be implemented in software, firmware or hardware, or combinations thereof and include any type of programmed step undertaken by components of the system; hence, illustrative components, blocks, modules, circuits, and steps are sometimes set forth in terms of their functionality.

A processor may be any conventional general purpose single- or multi-chip processor that can execute logic by means of various lines such as address lines, data lines, and control lines and registers and shift registers. Moreover, any logical blocks, modules, and circuits described herein can be implemented or performed with a general purpose processor, a digital signal processor (DSP), a field programmable gate array (FPGA) or other programmable logic device such as an application specific integrated circuit (ASIC), discrete gate or transistor logic, discrete hardware components, or any combination thereof designed to perform the functions described herein. A processor can also be implemented by a controller or state machine or a combination of computing devices. Thus, the methods herein may be implemented as software instructions executed by a processor, suitably configured application specific integrated circuits (ASIC) or field programmable gate array (FPGA) modules, or any other convenient manner as would be appreciated by those skilled in those art. Where employed, the software instructions may also be embodied in a non-transitory device that is being vended and/or provided that is not a transitory, propagating signal and/or a signal per se (such as a hard disk drive, CD ROM or Flash drive). The software code instructions may also be downloaded over the Internet. Accordingly, it is to be understood that although a software application for undertaking present principles may be vended with a device such as the system 100 described below, such an application may also be downloaded from a server to a device over a network such as the Internet.

Software modules and/or applications described by way of flow charts and/or user interfaces herein can include various sub-routines, procedures, etc. Without limiting the disclosure, logic stated to be executed by a particular module can be redistributed to other software modules and/or combined together in a single module and/or made available in a shareable library.

Logic when implemented in software, can be written in an appropriate language such as but not limited to C# or C++, and can be stored on or transmitted through a computer-readable storage medium (that is not a transitory, propagating signal per se) such as a random access memory (RAM), read-only memory (ROM), electrically erasable programmable read-only memory (EEPROM), compact disk read-only memory (CD-ROM) or other optical disk storage such as digital versatile disc (DVD), magnetic disk storage or other magnetic storage devices including removable thumb drives, etc.

In an example, a processor can access information over its input lines from data storage, such as the computer readable storage medium, and/or the processor can access information wirelessly from an Internet server by activating a wireless transceiver to send and receive data. Data typically is converted from analog signals to digital by circuitry between the antenna and the registers of the processor when being received and from digital to analog when being transmitted. The processor then processes the data through its shift registers to output calculated data on output lines, for presentation of the calculated data on the device.

Components included in one embodiment can be used in other embodiments in any appropriate combination. For example, any of the various components described herein and/or depicted in the Figures may be combined, interchanged or excluded from other embodiments.

“A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together, etc.

The term “circuit” or “circuitry” may be used in the summary, description, and/or claims. As is well known in the art, the term “circuitry” includes all levels of available integration, e.g., from discrete logic circuits to the highest level of circuit integration such as VLSI, and includes programmable logic components programmed to perform the functions of an embodiment as well as general-purpose or special-purpose processors programmed with instructions to perform those functions.

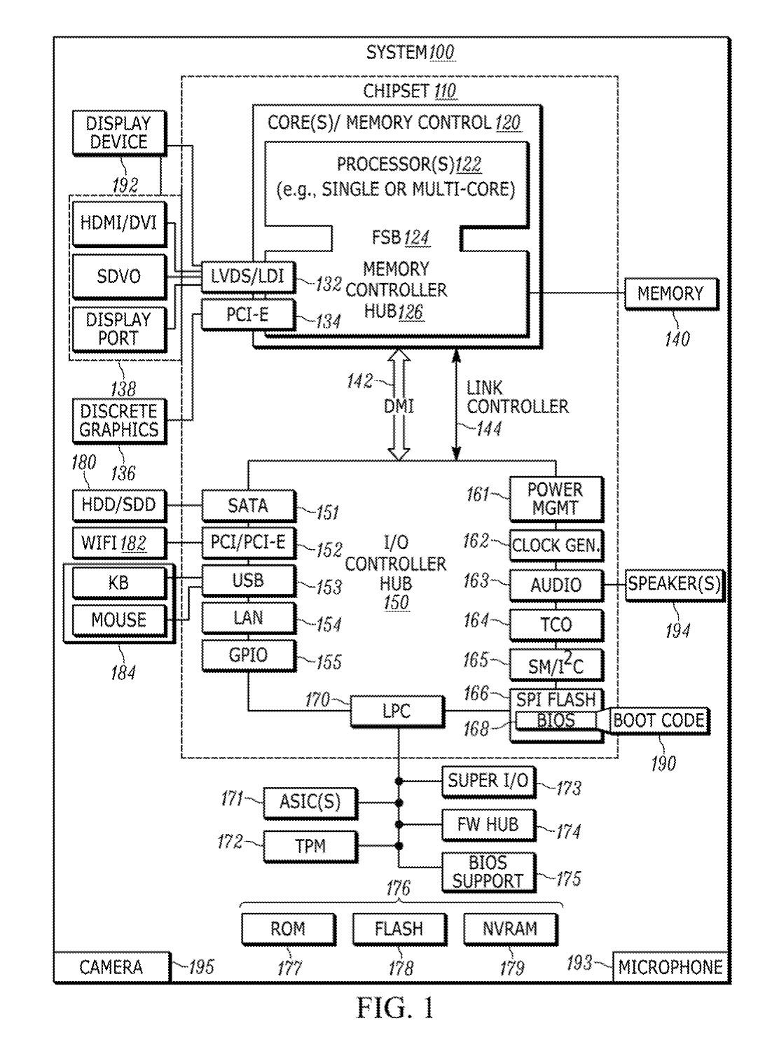

Now specifically in reference to FIG. 1, an example block diagram of an information handling system and/or computer system 100 is shown that is understood to have a housing for the components described below. Note that in some embodiments the system 100 may be a desktop computer system, such as one of the ThinkCentre® or ThinkPad® series of personal computers sold by Lenovo (US) Inc. of Morrisville, N.C., or a workstation computer, such as the ThinkStation®, which are sold by Lenovo (US) Inc. of Morrisville, N.C.; however, as apparent from the description herein, a client device, a server or other machine in accordance with present principles may include other features or only some of the features of the system 100. Also, the system 100 may be, e.g., a game console such as XBOX®, and/or the system 100 may include a mobile communication device such as a mobile telephone, notebook computer, and/or other portable computerized device.

As shown in FIG. 1, the system 100 may include a so-called chipset 110. A chipset refers to a group of integrated circuits, or chips, that are designed to work together. Chipsets are usually marketed as a single product (e.g., consider chipsets marketed under the brands INTEL®, AMD®, etc.).

In the example of FIG. 1, the chipset 110 has a particular architecture, which may vary to some extent depending on brand or manufacturer. The architecture of the chipset 110 includes a core and memory control group 120 and an I/O controller hub 150 that exchange information (e.g., data, signals, commands, etc.) via, for example, a direct management interface or direct media interface (DMI) 142 or a link controller 144. In the example of FIG. 1, the DMI 142 is a chip-to-chip interface (sometimes referred to as being a link between a “northbridge” and a “southbridge”).

The core and memory control group 120 include one or more processors 122 (e.g., single core or multi-core, etc.) and a memory controller hub 126 that exchange information via a front side bus (FSB) 124. As described herein, various components of the core and memory control group 120 may be integrated onto a single processor die, for example, to make a chip that supplants the conventional “northbridge” style architecture.

The memory controller hub 126 interfaces with memory 140. For example, the memory controller hub 126 may provide support for DDR SDRAM memory (e.g., DDR, DDR2, DDR3, etc.). In general, the memory 140 is a type of random-access memory (RAM). It is often referred to as “system memory.”

The memory controller hub 126 can further include a low-voltage differential signaling interface (LVDS) 132. The LVDS 132 may be a so-called LVDS Display Interface (LDI) for support of a display device 192 (e.g., a CRT, a flat panel, a projector, a touch-enabled display, etc.). A block 138 includes some examples of technologies that may be supported via the LVDS interface 132 (e.g., serial digital video, HDMI/DVI, display port). The memory controller hub 126 also includes one or more PCI-express interfaces (PCI-E) 134, for example, for support of discrete graphics 136. Discrete graphics using a PCI-E interface has become an alternative approach to an accelerated graphics port (AGP). For example, the memory controller hub 126 may include a 16-lane (×16) PCI-E port for an external PCI-E-based graphics card (including, e.g., one of more GPUs). An example system may include AGP or PCI-E for support of graphics.

In examples in which it is used, the I/O hub controller 150 can include a variety of interfaces. The example of FIG. 1 includes a SATA interface 151, one or more PCI-E interfaces 152 (optionally one or more legacy PCI interfaces), one or more USB interfaces 153, a LAN interface 154 (more generally a network interface for communication over at least one network such as the Internet, a WAN, a LAN, etc. under direction of the processor(s) 122), a general purpose I/O interface (GPIO) 155, a low-pin count (LPC) interface 170, a power management interface 161, a clock generator interface 162, an audio interface 163 (e.g., for speakers 194 to output audio), a total cost of operation (TCO) interface 164, a system management bus interface (e.g., a multi-master serial computer bus interface) 165, and a serial peripheral flash memory/controller interface (SPI Flash) 166, which, in the example of FIG. 1, includes BIOS 168 and boot code 190. With respect to network connections, the I/O hub controller 150 may include integrated gigabit Ethernet controller lines multiplexed with a PCI-E interface port. Other network features may operate independent of a PCI-E interface.

The interfaces of the I/O hub controller 150 may provide for communication with various devices, networks, etc. For example, where used, the SATA interface 151 provides for reading, writing or reading and writing information on one or more drives 180 such as HDDs, SDDs or a combination thereof, but in any case the drives 180 are understood to be, e.g., tangible computer readable storage mediums that are not transitory, propagating signals. The I/O hub controller 150 may also include an advanced host controller interface (AHCI) to support one or more drives 180. The PCI-E interface 152 allows for wireless connections 182 to devices, networks, etc. The USB interface 153 provides for input devices 184 such as keyboards (KB), mice and various other devices (e.g., cameras, phones, storage, media players, etc.).

In the example of FIG. 1, the LPC interface 170 provides for use of one or more ASICs 171, a trusted platform module (TPM) 172, a super I/O 173, a firmware hub 174, BIOS support 175 as well as various types of memory 176 such as ROM 177, Flash 178, and non-volatile RAM (NVRAM) 179. With respect to the TPM 172, this module may be in the form of a chip that can be used to authenticate software and hardware devices. For example, a TPM may be capable of performing platform authentication and may be used to verify that a system seeking access is the expected system.

The system 100, upon power on, may be configured to execute boot code 190 for the BIOS 168, as stored within the SPI Flash 166, and thereafter processes data under the control of one or more operating systems and application software (e.g., stored in system memory 140). An operating system may be stored in any of a variety of locations and accessed, for example, according to instructions of the BIOS 168.

The system may also include an audio receiver/microphone 193 that provides input from the microphone 193 to the processor 122 based on audio that is detected, such as via a user providing audible input to the microphone during a telephone call or other audio communication while the speakers 194 output audio from the other end(s) of the call in accordance with present principles. The system may further include camera 195 that gathers one or more images and provides input related thereto to the processor 122. The camera 195 may be a thermal imaging camera, a digital camera such as a webcam, a three-dimensional (3D) camera, and/or a camera otherwise integrated into the system 100 and controllable by the processor 122 to gather pictures/images and/or video, such as images to be used for eye tracking and video conferencing in accordance with present principles.

Additionally, though not shown for clarity, in some embodiments the system 100 may include a gyroscope that senses and/or measures the orientation of the system 100 and provides input related thereto to the processor 122, as well as an accelerometer that senses acceleration and/or movement of the system 100 and provides input related thereto to the processor 122. Still further, the system 100 may include a GPS transceiver that is configured to communicate with at least one satellite to receive/identify geographic position information and provide the geographic position information to the processor 122. However, it is to be understood that another suitable position receiver other than a GPS receiver may be used in accordance with present principles to determine the location of the system 100.

It is to be understood that an example client device or other machine/computer may include fewer or more features than shown on the system 100 of FIG. 1. In any case, it is to be understood at least based on the foregoing that the system 100 is configured to undertake present principles.

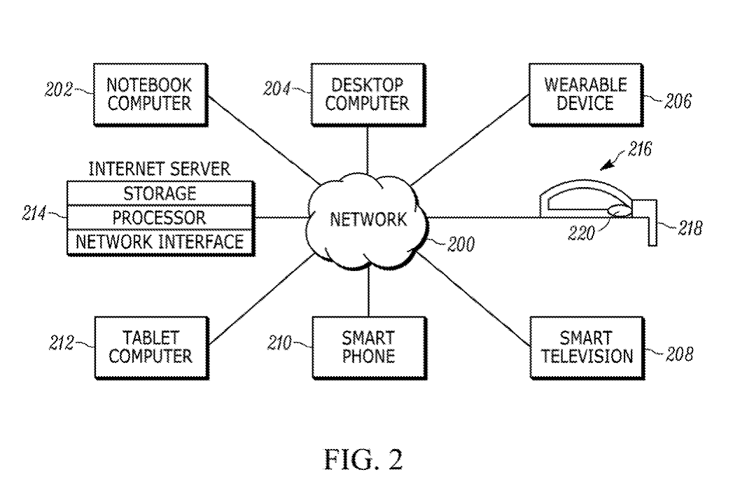

Turning now to FIG. 2, example devices are shown communicating over a network 200 such as the Internet in accordance with present principles. It is to be understood that each of the devices described in reference to FIG. 2 may include at least some of the features, components, and/or elements of the system 100 described above. Indeed, any of the devices disclosed herein may include at least some of the features, components, and/or elements of the system 100 described above.

FIG. 2 shows a notebook computer and/or convertible computer 202, a desktop computer 204, a wearable device 206 such as a smart watch, a smart television (TV) 208, a smart phone 210, a tablet computer 212, a headset 216 and a server 214 such as an Internet server that may provide cloud storage accessible to the devices 202-212, 216. It is to be understood that the devices 202-216 are configured to communicate with each other over the network 200 to undertake present principles.

Describing the headset 216 in more detail, it may be a virtual reality (VR) headset, an augmented reality (AR) headset, a pair of smart glasses, or even an earpiece headset for making telephone calls. It may include a head-mounted display 218 on which VR and AR images are presentable as well as the graphical elements described herein. The headset 216 may also include speakers for outputting audio in accordance with present principles as well as one or more cameras 220 so that the headset or a connected device may track a user's eyes in accordance with present principles based on input from the camera(s) 220 using eye tracking software.

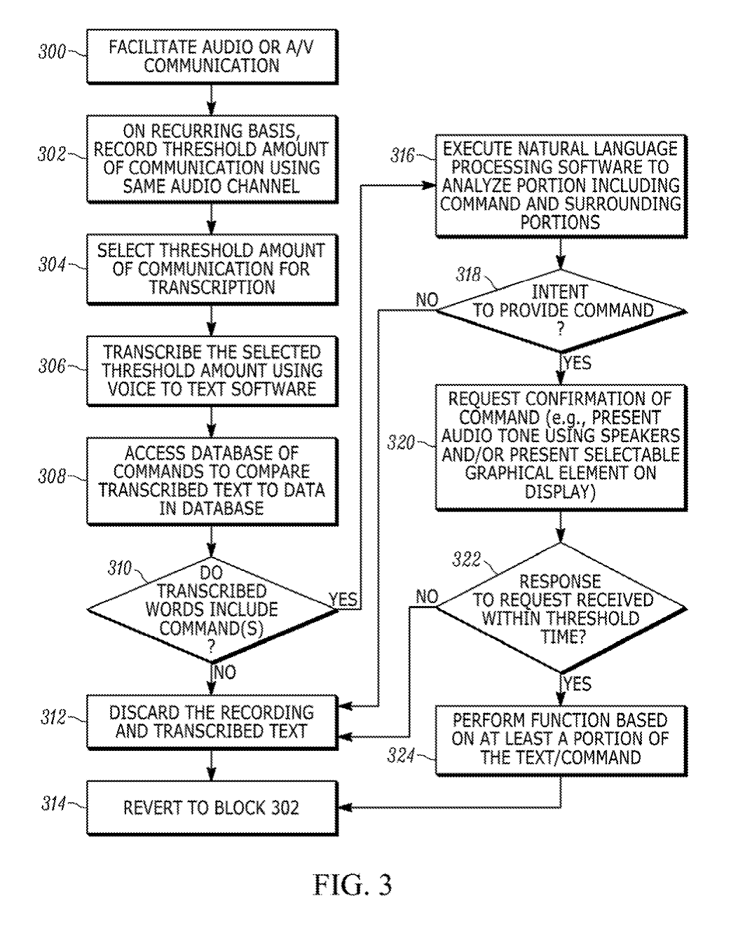

Referring to FIG. 3, it shows example logic that may be executed by a device such as the system 100 in accordance with present principles so that the device can recognize a voice command that might be provided by a user of the device while the user engages in a telephone call, video conference, or other audio communication with another person (or plural other people using their own respective devices to participate). Accordingly, at block 300 the device begins facilitating the communication using, e.g., a telephone application executing on the device or a video conferencing application executing on the device. Facilitating the communication may include placing or initiating a call to the other person, receiving a call from the other person, and/or maintaining a call that has already been initiated.

From block 300 the logic of FIG. 3 may proceed to block 302 where the device may, on a recurring basis, record a threshold non-zero amount of audio of the communication. The recording may be made using the same audio channel or microphone feed of the user speaking that is provided to the other person as part of the communication itself. For instance, the device may record, in series, consecutive audio segments of the user's input to the device's microphone so that there is no gap of words spoken by the user that are not recorded. Once an audio segment has been recorded, and sometimes while a subsequent segment is itself being recorded, the recorded segment may be analyzed by the device as set forth below to determine whether the user might have provided a voice command to the device to perform a function or execute a task, e.g., using the device's personal or digital assistant application as might be executing in the background. The assistant application may be similar to Apple's Siri, Amazon's Alexa, Google's Google Assistant, etc.

From block 302 the logic may proceed to block 304. At block 304 the device may select the recorded segment of audio of the communication so that it may be transcribed. The logic may then move to block 306 where, using voice to text software, the device may transcribe the words spoken by the user as indicated in the recorded audio segment. After block 306 the logic may proceed to block 308 where the device may access a database of voice commands that may be stored locally on the device or remotely on, e.g., a cloud server to which the device has access. The database itself may be, for example, a relational database of various words and corresponding entries for whether those words constitute a voice command for which the device's personal assistant should take action. Additionally or alternatively, the database may simply be a listing of words that, when recognized by the device, are to constitute a voice command for which the device's personal assistant should take action. Regardless, the device at block 308 may access the database and parse it until a match to one or more of the words from the transcribed audio segment are located in the database.

The logic may then proceed to decision diamond 310 where the device may determine, based on parsing the database, whether one or more words from the text of the transcription are indicated in the database. A negative determination at diamond 310 may cause the device to proceed to block 312 where the device may discard the transcription and/or the recorded audio segment itself (e.g., delete it or remove it from memory), after which the device may proceed to block 314. Block 314 may be an instruction for the logic to proceed back to block 302 and to proceed therefrom to analyze another, subsequently recorded audio segment.

However, if an affirmative determination is made at diamond 310 instead of a negative one, the logic of FIG. 3 may instead proceed to block 316. At block 316 the device may execute natural language processing software and/or natural language processing artificial intelligence to analyze one or both of the transcription and the recorded audio segment itself. In some embodiments, the device may analyze that data not just to identify the voice command itself but may also analyze portions of the segment/transcription preceding and after the voice command. In doing so, the device may determine, based on one or more identified contexts of the conversation, whether a voice command was in fact issued as initially identified by the device and may also determine any other information surrounding the voice command that might be helpful in executing the voice command.

Thus, from block 316 the logic may proceed to decision diamond 318 where the device may in fact determine, based on execution of the natural language processing software/artificial intelligence at block 316, whether there was an intent by the user to provide a voice command to the device to execute a function. A negative determination at diamond 318 may cause the logic to revert back to block 312 and proceed therefrom as described above. However, an affirmative determination at diamond 318 will instead cause the logic to block 320.

At block 320 the device may, as another step to confirm that a voice command has in fact been issued, request confirmation from the user of a voice command has actually being issued to the device. The confirmation request may take one or more different forms. For instance, the request may include presentation of a predetermined audio tone or chime via the device's speaker(s) that the user would know as being a cue that the device has picked up on a voice command to the device. A graphical element such as an icon or symbol may also be presented on the device's touch-enabled display as part of the request so that when the predetermined audio tone/chime is played the user has a threshold non-zero period of time to provide touch input selecting the graphical element to provide input confirming that a voice command has in fact been provided to the device. However, in other embodiments the graphical element itself might be provided without also providing the predetermined audio tone/chime, as might be appropriate if the user were engaging in video conferencing and were already looking at the display anyway as part of the conferencing.

Accordingly, from block 320 the logic may proceed to decision diamond 322 where the device may determine whether a response to the request was received within a threshold non-zero time of one or both of the predetermined chime/tone being played and the graphical element being presented. For example, the threshold time may be thirty seconds. A negative determination will cause the logic to revert back to block 312 and proceed therefrom as described above. However, an affirmative determination at diamond 322 will instead cause the logic to block 324. At block 324 the device may perform a function or task indicated by the voice command and any surrounding portions that might provide context for the voice command.

As an example, the voice command may be “Okay assistant, what is the weather like over there?” Then, based on that command and the device also identifying that Morrisville, N.C. was being discussed in surrounding parts of the conversation, the device may access weather information over the Internet to determine the current weather in Morrisville, N.C. to report to the user. Other examples of voice commands may include commands to create electronic calendar entries, commands to find recipes for a particular type of dinner, commands to add tasks to a “to do” list, commands to turn on other devices such as TVs or smart home lights, or any other commands that might be provided to a personal assistant application.

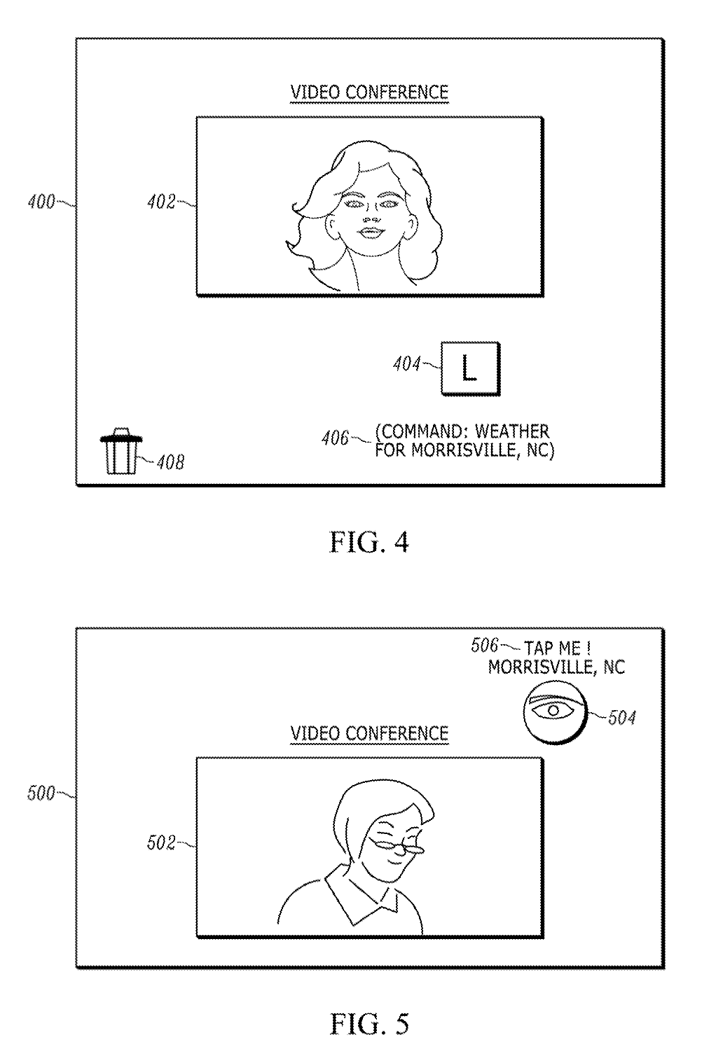

Continuing the detailed description in reference to FIG. 4, it shows an example graphical user interface (GUI) 400 that may be presented on the display of a device undertaking present principles. The GUI 400 may be a GUI associated with a video conferencing application, and it is to be understood in FIG. 4 that a video conference is currently being facilitated by the device. Thus, a video feed 402 of a person on the other end of the video conference is presented via the GUI 400.

FIG. 4 also shows that an icon 404 may be presented. The icon 404 is one example of a graphical element that might be presented at block 320 as described above. In this example, the graphical element is a symbol associated with a Lenovo personal assistant application that is executing at the device to execute voice commands that might be provided by the user during the video conference. The icon 404 may be selected by the user to confirm the user's voice command by directing touch or cursor input to it as presented on a touch-enabled display. In some embodiments, touching or clicking on the icon 404 for any period of time may constitute selection, while in other embodiments the icon 404 may be touched or clicked for a threshold non-zero amount of time (e.g., five seconds).

Conversely, the user not selecting the icon 404 within a threshold non-zero amount of time of presentation of the icon 404, the user selecting the icon 404 but not for the threshold selection time referenced in the paragraph immediately above, and/or the user gesturing another predetermined gesture other than to select the icon 404 with his or her finger may be interpreted by the device as one or more of the following: input that a voice command was not provided, input that the device should not take action in conformance with the voice command, and/or input that the icon 404 should be deleted/removed from the GUI 400 without taking action in conformance with the voice command. The predetermined gesture referenced in the sentence immediately above may be, for example, a drag and drop gesture using the user's hand or the device's cursor to drag and drop the icon 404 in a graphical trash can 408 presented on the device's display. The predetermined gesture may also be a dragging or swiping of the icon 404 offscreen by the user taking his or her index finger and swiping against the device's touch-enabled display to swipe the icon 404 off the display.

Still in reference to FIG. 4, also note that the icon 404 may be accompanied by textual information as well. For example the icon 404 may be accompanied by information 406 indicating the voice command as the device has identified it from the context of the user's conversation with the other person on the other end of the video conference, which in this case is a request for information on the weather in Morrisville, N.C. Note that in some embodiments, the voice command and/or context may be identified not just from words spoken by the user but also from words spoken by the person on the other end of the call based on the spoken words of the other person being analyzed/transcribed by the device as well.

FIG. 5 shows another example GUI 500 in accordance with present principles. However, it is to be understood in the context of FIG. 5 that the GUI 500 is a GUI that may be presented as part of virtual reality (VR) or augmented reality (AR) processing to present images on the display of a VR/AR headset or smart glasses the user might be wearing to engage in a video or telephone conference with another person. Notwithstanding, the GUI 500 may still be a GUI associated with a video conferencing application and it is to be understood in reference to FIG. 5 that a video conference is currently being facilitated by the headset. Thus, a video feed 502 of a person on the other end of the video conference is presented via the GUI 500.

FIG. 5 also shows that an icon 504 may be presented. The icon 504 is another example of a graphical element that might be presented at block 320 as described above. In this example, the graphical element is a bulls-eye or target three-dimensional VR or AR object that is associated with a Lenovo personal assistant application that is executing at the device to execute voice commands that might be provided by the user during the video conference. The icon 504 may be selected by the user to confirm the user's voice command by the user gazing at the icon 504 for a threshold non-zero amount of time (e.g., ten seconds). The gaze for the threshold amount of time may be identified based on input from a camera on the headset that is oriented to image the user's eyes so that the headset or another device in communication with it can track the user's eye movement using eye tracking software executing at the headset/other device.

Additionally or alternatively, the icon 504 may be selected by the user to confirm the user's voice command by the user gazing at the icon 504 for a threshold non-zero amount of time and by the user also providing a gesture with his or her hand that the headset or a connected device would recognize as a predetermined gesture indicating user confirmation. For example, one or more cameras within the user's environment or on the headset itself may gather images of the user and provide them to the headset's processor (or a connected device's processor) for the processor to execute gesture recognition using the images to identify the gesture as a “thumbs up” gesture with the user's hand that indicates user confirmation of the voice command.

Additionally or alternatively, the predetermined gesture may be an “air tap” where a user uses his or her index finger to provide a tapping gesture in free space where the icon 504 appears to the user to exist in 3D space owing to the headset using AR or VR processing to present the icon 504 in such a manner. The “tapping” on the icon 504 as it appears to the user may thus be interpreted by the headset as selection of the icon 504 and hence user confirmation of the voice command the headset has identified.

Notwithstanding the foregoing, also note that in some embodiments identification of the predetermined gesture without also identifying the user gazing at the icon 504 past the threshold amount of time may still constitute confirmation from the user.

In any case, it is to be further understood that a user's gaze at the icon 504 for less than the threshold amount of time, the user not looking at the icon 504 at all, and/or the user gesturing another predetermined gesture may be interpreted by the headset as one or more of the following: input that a voice command was not provided, input that the headset should not take action in conformance with the voice command, and/or input that the icon 504 should be deleted/removed from the GUI 500 without taking action in conformance with the voice command. This predetermined “no” gesture may be, for example, a “thumbs down” gesture using the user's hand.

This predetermined “no” gesture may also include the user pressing and holding the icon 504 using his or her index finger where the icon 504 appears to the user to exist in 3D space owing to the headset using AR or VR processing to present the icon 504 in such a manner. Once the headset identifies the user as pressing and holding the icon 504 for a threshold non-zero amount of time, the headset may enable the user to drag the icon 504 offscreen by taking his or her index finger and swiping in free space from where the icon 504 appears to be presented to another location, relative to the user, that cannot be seen by the user while wearing the headset (such as down and to the right of the user's right leg).

Still in reference to FIG. 5, note that the icon 504 may also be accompanied by textual information such as information 506 indicating the voice command as the headset has identified it from the context of the video conferencing conversation. In this example, the information 506 also indicates an action that the user may take to confirm the voice command, which in this case is a “tap me” instruction for the user to select the icon 504.

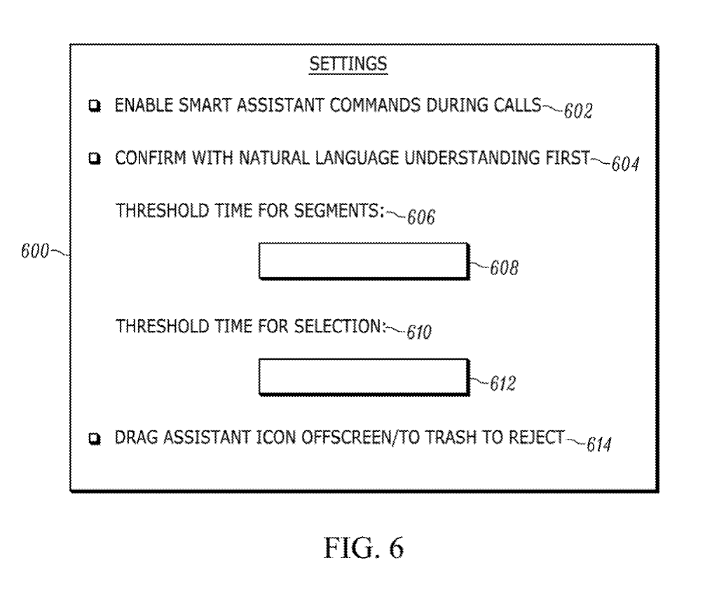

Before moving on to the description of FIG. 6, also note that selecting by gazing as described above in reference to the icon 504 may also be used for selecting an icon such as the icon 404 even if not presented using a headset. So, for example, if the user were using a laptop having a display on which the icon 404 were presented, the laptop may execute eye tracking using images from its camera to identify the user as gazing at the icon for a threshold amount of time and interpret that as selection of the icon.

Now describing FIG. 6, it shows an example settings GUI 600 that is presentable on a display accessible to a device undertaking present principles for configuring settings of the device. The GUI 600 may thus include a first option 602 that is selectable by directing touch or cursor input to the check box adjacent to it to enable a setting for the device in which the device may analyze an audio stream of an audio communication to identify voice commands as set forth herein. For example, a user may select option 602 to enable the device to undertake the logic of FIG. 3.

The GUI 600 may also include an option 604 that is selectable by directing touch or cursor input to the check box adjacent to it to enable a setting for the device in which, prior to requesting confirmation of a voice command from a user, the device may use natural language understanding software as described herein. For example, a user may select option 604 to enable the device to execute step 316 of FIG. 3.

Even further, the GUI 600 may include a setting 606 for a user to establish the length of the threshold amount of audio that is to be recorded as, e.g., referenced above when describing blocks 302 and 304. Thus, a user may direct input to input box 608 by selecting it with touch input or a cursor and then using a soft or hard keyboard to specify a particular length of time, such as fifteen seconds, to establish as the threshold amount of time.

The GUI 600 may also include a setting 610 for a user to establish the threshold amount of time for selection of a graphical element as disclosed herein. Accordingly, a user may direct input to input box 612 by selecting it with touch input or a cursor and then using a soft or hard keyboard to specify a particular length of time, such as five seconds.

FIG. 6 also shows that the GUI 600 may include an option 614 that is selectable by directing touch or cursor input to the check box adjacent to it to enable dragging of a graphical element offscreen or to a graphical trash can as described herein to reject the device's identification of the user as providing a voice command.

It is to be understood that whilst present principals have been described with reference to some example embodiments, these are not intended to be limiting, and that various alternative arrangements may be used to implement the subject matter claimed herein. Components included in one embodiment can be used in other embodiments in any appropriate combination. For example, any of the various components described herein and/or depicted in the Figures may be combined, interchanged or excluded from other embodiments.

What is claimed is:

1. A first device, comprising:
at least one processor; and
storage accessible to the at least one processor and comprising instructions executable by the at least one processor to:
facilitate audio communication between the first device and a second device different from the first device;
select a threshold amount of the audio communication, the threshold amount not comprising the entirety of the audio communication;
transcribe to text words that are recognized from the threshold amount of the audio communication;
determine whether the text comprises a command to the first device; and
based on a determination that the text comprises a command to the first device, request confirmation that a command to the first device has been issued.

2. The first device of claim 1, comprising a display accessible to the at least one processor, and wherein the instructions are executable by the at least one processor to:
request confirmation that a command to the first device has been issued at least in part by presenting a graphical element on the display.

3. The first device of claim 2, wherein the graphical element is selectable to provide input confirming that a command to the first device has been issued, and wherein the instructions are executable by the at least one processor to:
responsive to selection of the graphical element, perform a function based on at least a portion of the text.

4. The first device of claim 1, wherein the instructions are executable by the at least one processor to:
request confirmation that a command to the first device has been issued at least in part by presenting a predetermined sound via at least one speaker.

5. The first device of claim 1, wherein the instructions are executable by the at least one processor to:
based on a determination that the text comprises a command to the first device, execute natural language processing to analyze the threshold amount of the audio communication;
determine, based on the natural language processing, an intent to provide a command to the first device; and
responsive to the determination of an intent to provide a command to the first device, request confirmation that a command to the first device has been issued.

6. The first device of claim 1, wherein the audio communication comprises one or more of: audio communication between two users, audio video communication between two users.

7. The first device of claim 1, wherein the words are transcribed to text using voice to text software.

8. The first device of claim 1, wherein the instructions are executable by the at least one processor to:
determine whether the text comprises a command to the first device at least in part by comparing at least a portion of the text to data in a database of commands to identify whether at least one word that is recognized from the threshold amount of the audio communication is indicated in the database; and
determine that the text comprises a command to the first device at least in part based on at least one word that is recognized from the threshold amount of the audio communication being indicated in the database.

9. The first device of claim 1, wherein the text is first text, wherein the threshold amount of the audio communication is a first threshold amount of the audio communication, and wherein the instructions are executable by the at least one processor to:
responsive to a determination that the first text does not comprise a command to the first device, discard the first text;
select a second threshold amount of the audio communication, the second threshold amount not comprising the entirety of the audio communication;
transcribe to second text words that are recognized from the second threshold amount of the audio communication;
determine whether the second text comprises a command to the first device; and
based on a determination that the second text comprises a command to the first device, request confirmation that a command to the first device has been issued.

10. A method, comprising:
facilitating audio communication between a first device and a second device different from the first device;
selecting a threshold amount of the audio communication, the threshold amount not comprising the entirety of the audio communication;
converting to text words that are recognized from the threshold amount of the audio communication;
determining whether the text comprises a command to a device; and
presenting, based on determining that the text comprises a command to the device, a request to confirm that a command to the device has been provided.

11. The method of claim 10, comprising:
presenting the request at least in part by presenting an icon on a display.

12. The method of claim 10, comprising:
executing, based on determining that the text comprises a command to the device, natural language processing software to analyze the threshold amount of the audio communication;
identifying, based on executing the natural language processing software, an intent to provide a command to the device; and
presenting the request responsive to identifying the intent to provide a command to the device.

13. The method of claim 10, wherein the audio communication comprises one or more of: audio communication between two users, audio video communication between two users.

14. The method of claim 10, wherein the words are converted to text using voice to text software.

15. The method of claim 10, comprising:
determining whether the text comprises a command to the device at least in part by comparing at least a portion of the text to data in a database of commands to identify whether at least one word that is recognized from the threshold amount of the audio communication is indicated in the database; and
determining that the text comprises a command to the device at least in part based on at least one word that is recognized from the threshold amount of the audio communication being indicated in the database.

16. The method of claim 10, comprising:
discarding the text responsive to determining that the text does not comprise a command to the device.

17. The method of claim 10, comprising:
discarding the text responsive to a response to the request not being received within a threshold amount of time of the request being presented.

18. A computer readable storage medium (CRSM) that is not a transitory signal, the computer readable storage medium comprising instructions executable by at least one processor to:
facilitate audio communication between a first device and a second device different from the first device;
convert to text at least one word that is recognized from the audio communication;
determine whether the text comprises a command to a device; and
present, based on a determination that the text comprises a command to the device, a request to confirm that a command to the device has been provided.

19. The CRSM of claim 18, wherein the instructions are executable by the at least one processor to:
present the request at least in part based on presentation of a graphical element on a display, the graphical element being selectable by a user to confirm that a command to the device has been provided.

20. The CRSM of claim 18, wherein the instructions are executable by the at least one processor to:
use the same audio channel to facilitate the audio communication and to determine whether the text comprises a command to a device.
